(19) United States
(12) Patent Application Publication
(10) Pub. No.: US 2021/0084134 A1
(43) Pub. Date: Mar. 18, 2021

(54) ELECTRONIC DEVICE

(71) Applicant: FUJITSU CLIENT COMPUTING LIMITED, Kanagawa (JP)

(72) Inventors: Kenji Suzuki, Kawasaki (JP); Yoshiyuki Sando, Kawasaki (JP); Yasufumi Yamamoto, Kawasaki (JP)

(73) Assignee: FUJITSU CLIENT COMPUTING LIMITED, Kanagawa (JP)

(21) Appl. No.: 16/929,485

(22) Filed: Jul. 15, 2020

(30) Foreign Application Priority Data
Sep. 17, 2019 (JP) 2019-168438

(51) Int. Cl. H04M 1/02

(52) U.S. Cl. CPC H04M 1/0249; H04M 1/0274

(57) ABSTRACT

An electronic device includes a support member, a male screw member, a first component, and a female screw. The support member includes a first surface facing in a first direction and a second surface facing in the first direction. The male screw member includes a head portion positioned in the first direction with respect to the first surface and the second surface and spaced apart from the first surface and the second surface and a shaft portion extending from the head portion in a direction opposite to the first direction. The first component is sandwiched between the head portion and the first surface. The female screw is joined to the shaft portion and fixes the male screw member to the support member. The first surface and the second surface are at different positions in the first direction and in the circumferential direction of the shaft portion.

### CROSS-REFERENCE TO RELATED APPLICATIONS

This application is based upon and claims the benefit of priority from Japanese Patent Application No. 2019-168438, filed on Sep. 17, 2019, the entire contents of which are incorporated herein by reference.

### FIELD

Embodiments described herein relate generally to an electronic device.

### BACKGROUND

Conventionally known configurations for an electronic device such as a personal computer include one in which two components are jointly fastened by a male screw member for the purposes of, for example, size reduction and reduction of the number of assembly steps (e.g., see Japanese Patent Application Laid-open No. 2013-130969.

Electronic devices each having such a configuration may be produced, for example, on a build-to-order (BTO) basis, which allows users to select specifications. In such a case, two male screw members having different lengths need to be prepared to correspond to different specifications, that is, one to include two components and another to include only one of the two components, and the number of kinds of male screw member thus increases inevitably.

One of objects of the present invention is to obtain an electronic device that makes it possible to avoid increase in the number of kinds of male screw member.

### SUMMARY

An electronic device according to the first aspect of the present invention includes: a support member including a first surface and a second surface, the first surface facing in a first direction, the second surface facing in the first direction; a male screw member including a head portion and a shaft portion, the head portion being positioned in the first direction with respect to the first surface and the second surface and spaced apart from the first surface and the second surface, the shaft portion extending from the head portion in a direction opposite to the first direction; a first component sandwiched between the head portion and the first surface; and a female screw joined to the shaft portion and fixing the male screw member to the support member. The first surface and the second surface are at different positions in the first direction and in a circumferential direction of the shaft portion.

### BRIEF DESCRIPTION OF THE DRAWINGS

FIG. 1 is an illustrative perspective view, as viewed from the front, of two electronic devices according to one or more embodiments;

FIG. 2 is an illustrative perspective view, as viewed from the front, of a rear unit in the electronic device (first electronic device) according to one or more embodiments;

FIG. 3 is an illustrative exploded perspective view, as viewed from the front, of the rear unit in the electronic device (first electronic device) according to the embodiment;

FIG. 4 is an illustrative perspective view of a part of the rear unit in the electronic device (first electronic device) according to one or more embodiments;

FIG. 5 is an illustrative sectional view of a part of the rear unit in the electronic device (first electronic device) according to one or more embodiments;

FIG. 6 is an illustrative perspective view of a part of the rear unit in the electronic device (first electronic device) according to one or more embodiments, from which a circuit substrate and a male screw member are omitted; and

FIG. 7 is an illustrative sectional view of a part of a rear unit in the electronic device (second electronic device) according to one or more embodiments.

### DETAILED DESCRIPTION

The following discloses an illustrative embodiments according to the present invention. The configurations of the following embodiments and the operational effects produced by these configurations are examples. The present invention can be implemented through configurations other than those disclosed in the following embodiments. According to the present invention, at least one out of various effects (including secondary effects) produced by the configurations can be obtained.

In the present specification, ordinal numbers are used for distinguishing between components, members, portions, positions, directions, and the like, and are not intended to indicate an order or priorities.

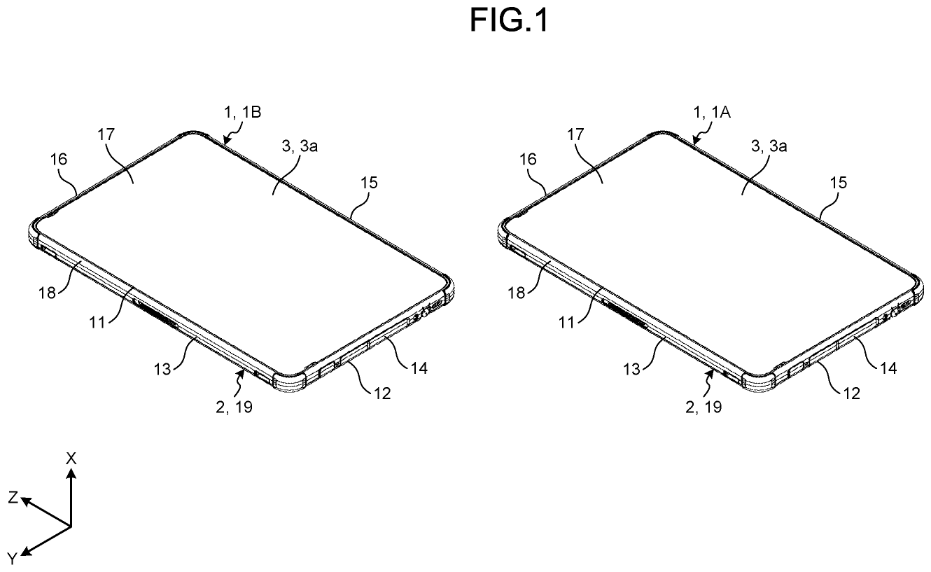

FIG. 1 is a perspective view, as viewed from the front, of two electronic devices 1. Two electronic devices 1 are each configured as, for example, a tablet personal computer. The two electronic devices 1 are configured identically to each other except for some components housed in casings 2. In the following description, the two electronic devices 1 are also referred to as “first electronic device 1A” and “second electronic device 1B” when the two electronic devices 1 are distinguished from each other. Each of the electronic devices 1 is not limited to the above example and may be configured as, for example, a desktop personal computer, a clamshell (notebook) personal computer, a video display apparatus, a television receiver, a game machine, a video display control apparatus, or an information storage device.

In one or more embodiments, three directions perpendicular to each other are defined for the sake of convenience. An X-direction extends along the thickness directions (frontward and rearward directions) of the electronic device 1; a Y-direction extends along the short-side directions (transverse width directions) of the electronic device 1; and a Z-direction extends along the long-side directions (longitudinal width directions) of the electronic device 1. The following description refers to: the X-direction also as “frontward direction”; a direction opposite to the X-direction also as “rearward direction”; the Y-direction also as “leftward direction”; a direction opposite to the Y-direction also as “rightward direction”; the Z-direction also as “upward direction”; and a direction opposite to the Z-direction also as “downward direction”.

The following first describes the first electronic device 1A and then describes the second electronic device 1B.

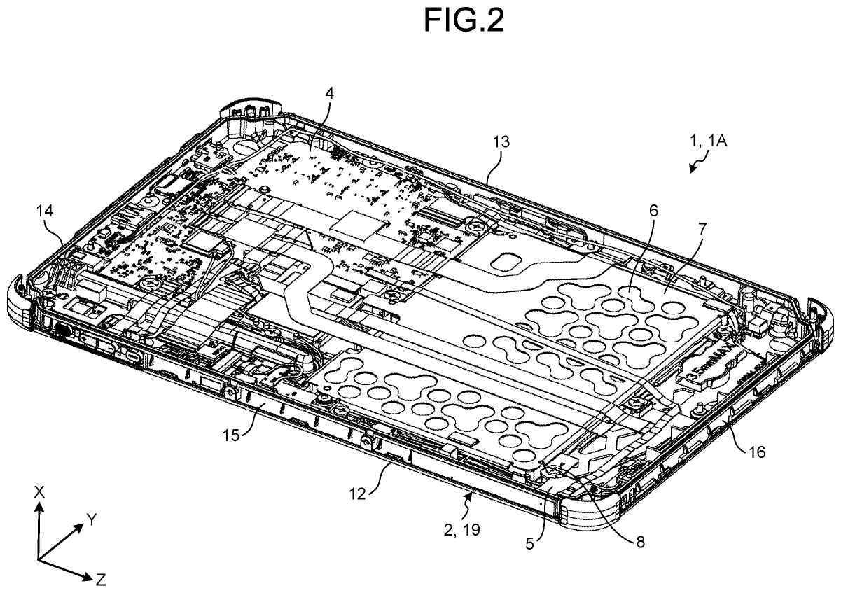

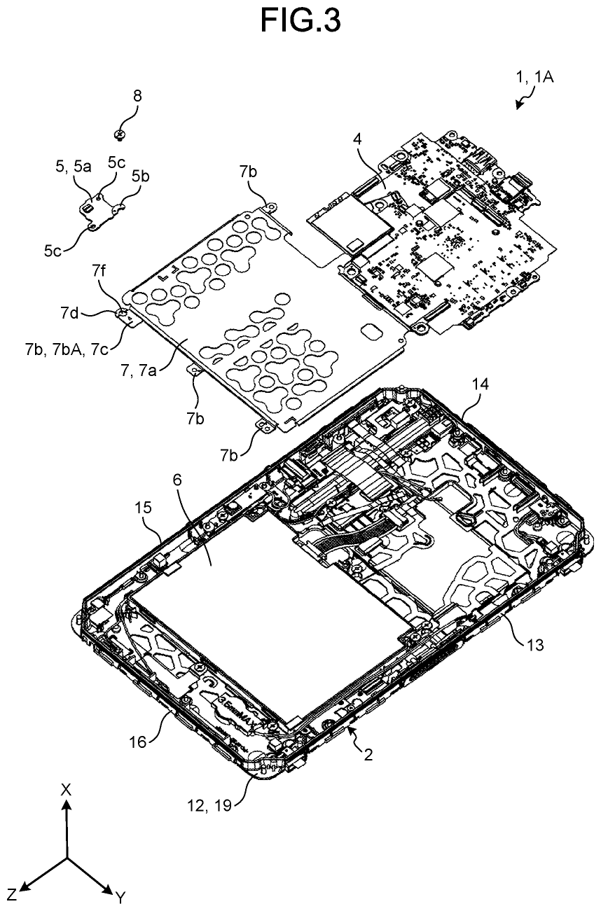

FIG. 2 is an illustrative exploded perspective view, as viewed from the front, of the electronic device 1 (first electronic device 1A). FIG. 3 is an illustrative exploded perspective view, as viewed from the front, of the rear unit in the electronic device 1 (first electronic device 1A).

As illustrated in FIG. 1 to FIG. 3, the first electronic device 1A includes the casing 2. The casing 2 has components housed therein such as a display unit 3, circuit substrates 4 and 5 (FIG. 2), a battery 6 (FIG. 2), and a sheet metal member 7 that is used for fixing the battery 6 to the casing 2. The sheet metal member 7 is an example of a first component, and the circuit substrate 5 is an example of a second component.

The shape of the casing 2 is a flat and substantially rectangular box shape. The casing 2 has: a front wall 11 from which a display screen 3a of the display unit 3 is exposed; a rear wall 12 positioned opposite the front wall 11; and a plurality of side walls 13 to 16 continuing from the front wall 11 to the rear wall 12.

The front wall 11 is formed in a rectangular frame shape. A front surface 11a of the front wall 11 and a display screen 3a is covered with a transparent member 17. The front surface 11a of the front wall 11 constitutes the front surface of the casing 2.

The rear wall 12 is provided spaced from the front wall 11 in the X-direction and extends in directions perpendicular to the X-direction (on a YZ-plane). The shape of the rear wall 12 is a quadrangle in a front view, specifically, a rectangle in a front view.

The side walls 13 and 15 each extend in directions perpendicular to the Y-direction (on an XZ-plane) and are provided spaced from each other in the Y-direction and parallel to each other. The side walls 14 and 16 each extend in directions perpendicular to the Z-direction (on an XY-plane) and are provided spaced from each other in the Z-direction and parallel to each other.

The casing 2 is configured as a combination of a plurality of members including a front cover 18 and a rear cover 19. The front cover 18 includes the front wall 11 and respective parts of the side walls 13 to 16. The rear cover 19 includes the rear wall 12 and respective parts of the side walls 13 to 16. The front cover 18 and the rear cover 19 are joined together by fasteners such as claws or screws. While the front cover 18 together with the display unit 3 constitutes a front unit, the rear cover 19 together with a circuit substrate 4 constitutes a rear unit.

As illustrated in FIG. 3, the sheet metal member 7 has a base part 7a and a plurality of fixation pieces 7b projecting from the base part 7a. The base part 7a is laid on the battery 6. The fixation pieces 7b are fixed to the rear cover 19. The sheet metal member 7 thereby fixes the battery 6 to the rear cover 19. The sheet metal member 7 is made of an electroconductive metal material. The sheet metal member 7 is a grounding member.

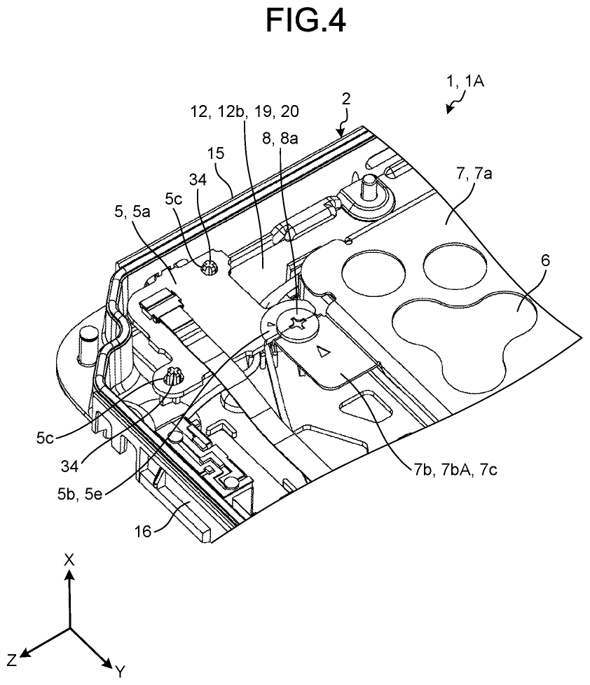

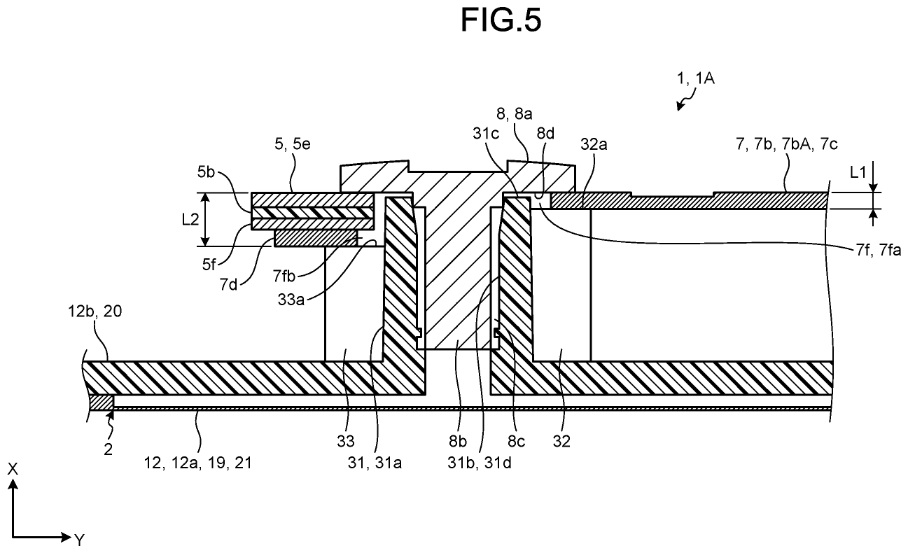

FIG. 4 is an illustrative perspective view of a part of the rear unit in the electronic device 1 (first electronic device 1A). FIG. 5 is an illustrative sectional view of a part of the rear unit in the electronic device 1 (first electronic device 1A).

As illustrated in FIG. 4 and FIG. 5, a fixation piece 7bA, one of the fixation pieces 7b, is fixed to the rear cover 19 by being fastened thereto together with the circuit substrate 5 by a male screw member 8.

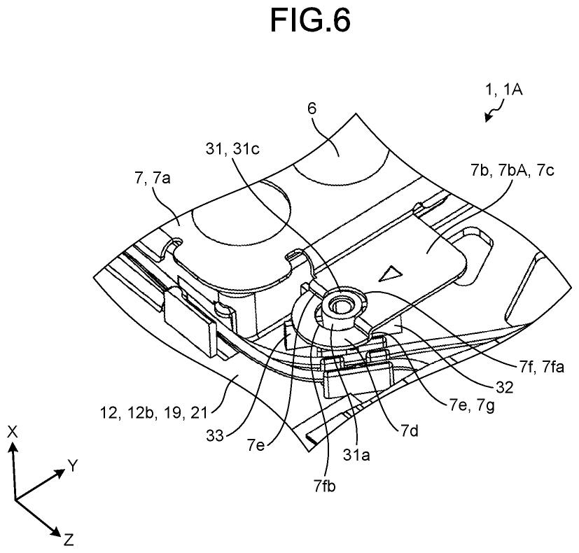

FIG. 6 is an illustrative perspective view of a part of the rear unit in the electronic device 1 (first electronic device 1A), from which the circuit substrate 5 and the male screw member 8 are omitted.

As illustrated in FIG. 6, the fixation piece 7bA includes a first part 7c, a second part 7d, and connection parts 7e. The first part 7c is configured in a plate-like shape and is connected to the base part 7a. The second part 7d is configured in a plate-like shape and is positioned further in a direction opposite to the X-direction than the first part 7c is. The connection parts 7e connect the first part 7c and the second part 7d together. The connection parts 7e constitute a stepped part 7g. The fixation piece 7bA is provided with a through-hole 7f. The through-hole 7f is provided across the first part 7c, the second part 7d, and the connection parts 7e. Therefore, the through-hole 7f includes: a first part 7fa provided in the first part 7c; and a second part 7fb provided in the second part 7d. While the first part 7fa of the through-hole 7f is configured as a notch in the first part 7c of the fixation piece 7bA, the second part 7fb of the through-hole 7f is configured as a notch in the second part 7d of the fixation piece 7bA.

As illustrated in FIG. 5, the male screw member 8 includes: a head portion 8a; a shaft portion 8b extending from the head portion 8a in the direction opposite to the X-direction; and a male screw 8c provided on the outer circumferential surface of the shaft portion 8b. The male screw member 8 is made of an electroconductive metal material. The X-direction is an example of a first direction.

The circuit substrate 5 illustrated in FIG. 3 and FIG. 4 is, for example, used for wireless communication and connected to an antenna. The circuit substrate 5 includes a base part 5a and a fixation piece 5b. The base part 5a is provided with an electronic circuit. The base part 5a is provided with a through-hole 5c. This through-hole 5c has a positioning protrusion 34 inserted therethrough that is provided to the rear cover 19. The base part 5a is thereby positioned, and the circuit substrate 5 is consequently positioned.

The fixation piece 5b is configured in a plate-like shape and projects from the base part 5a. As illustrated in FIG. 5, the fixation piece 5b includes a pair of electroconductive parts 5e and 5f. The electroconductive parts 5e and 5f are, for example, made of an electroconductive material such as copper. The electroconductive parts 5e and 5f are electrically connected to the electronic circuit of the base part 5a. The electroconductive parts 5e and 5f are grounding parts of the circuit substrate 5.

Next, fixation of the fixation piece 7bA of the sheet metal member 7 and the fixation piece 5b of the circuit substrate 5 to the rear cover 19 is described in detail.

As illustrated in FIG. 5, the rear cover 19 includes an inner cover member 20 and an outer cover member 21 covering the inner cover member 20. The inner cover member 20 and the outer cover member 21 are fixed to each other. The inner cover member 20 and the outer cover member 21 include respective parts of the rear wall 12. While an inner surface 12b of the inner cover member 20 is also an inner surface of the rear wall 12, an outer surface 12a of the outer cover member 21 is also an outer surface of the rear wall 12. The inner cover member 20 is made of a synthetic resin material. The inner cover member 20 is an example of a support member.

The inner cover member 20 includes a boss 31 and a plurality of ribs 32 and 33. The boss 31 and the ribs 32 and 33 project from the inner surface 12b of the rear wall 12 in the X-direction.

The boss 31 is configured in a circular cylindrical shape and has an outer circumferential surface 31a, an inner circumferential surface 31b, and an end surface 31c that faces in the X-direction. The inside of the boss 31 opens in the X-direction and in the direction opposite to the X-direction. A female screw 31d is provided on the inner circumferential surface 31b. The end surface 31c faces in the X-direction. The boss 31 is inserted in the through-hole 7f in the fixation piece 7bA of the sheet metal member 7. The diameter of the boss 31 is smaller than the diameter of the through-hole 7f. The female screw 31d and the male screw 8c of the shaft portion 8b are joined together with the shaft portion 8b of the male screw member 8 inserted in the inside of the boss 31. The female screw 31d fixes the male screw member 8 to the inner cover member 20. The female screw 31d is formed by, for example, having the male screw member 8 screwed into the boss 31. That is, the male screw member 8 is a self-tapping screw, and the boss 31 is a self-tapping boss. The head portion 8a of the male screw member 8 is positioned further in the X-direction than the end surface 31c is. The end surface 31c and a surface 8d of the head portion 8a that faces in the direction opposite to the X-direction are spaced from each other. The boss 31 is referred to also as “salient portion”.

Each of the ribs 32 and 33 is provided along the inner surface 12b of the rear wall 12 and the outer circumferential surface 31a of the boss 31. Each of the numbers of ribs 32 and ribs 33 may be two or more or may be one. The ribs 32 and 33 have respective end surfaces 32a and 33a facing in the X-direction. The end surfaces 32a and 32b both face in the X-direction. The head portion 8a of the male screw member 8 is positioned on a side in the X-direction with respect to the end surface 32a and the end surface 33a. The end surface 32a and the end surface 33a are spaced from the head portion 8a.

The end surface 32a and the end surface 33a are different positions in the X-direction and in the circumferential direction of the shaft portion 8b (boss 31). More specifically, the end surface 32a is positioned further in the X-direction than the end surface 33a is. That is, a distance L1 between the end surface 32a and the head portion 8a in the X-direction is smaller than a distance L2 between the end surface 33a and the head portion 8a in the X-direction. The end surface 32a is positioned further in the Y-direction than the end surface 33a is. The end surface 32a is an example of a first surface, and the end surface 33a is an example of a second surface.

While the first part 7c of the fixation piece 7bA in the sheet metal member 7 is sandwiched between the head portion 8a and the end surface 32a, the second part 7d of the fixation piece 7bA in the sheet metal member 7 and the fixation piece 5b of the circuit substrate 5 are sandwiched between the head portion 8a and the end surface 33a. That is, the sheet metal member 7 and the circuit substrate 5 are collectively fastened and fixed to the inner cover member 20 by the single male screw member 8. In this state, the fixation piece 5b of the circuit substrate 5 is laid on the second part 7d of the fixation piece 7bA in the sheet metal member 7 in the X-direction. Herein, the thickness of the second part 7d of the fixation piece 7bA in the sheet metal member 7 in the X-direction and the thickness of the fixation piece 5b of the circuit substrate 5 in the X-direction are both smaller than the distance L2 between the end surface 33a and the head portion 8a in the X-direction.

In the above fixed state, the electroconductive part 5f in the fixation piece 5b of the circuit substrate 5 makes contact with and is electrically connected to the second part 7d of the fixation piece 7bA in the sheet metal member 7. That is, the sheet metal member 7 is electrically connected to the circuit substrate 5 by having the second part 7d in contact with the circuit substrate 5. While the electroconductive part 5e of the fixation piece 5b of the circuit substrate 5 makes contact with and is electrically connected to the head portion 8a of the male screw member 8, the head portion 8a makes contact with and is electrically connected to the second part 7d of the fixation piece 7bA in the sheet metal member 7. That is, the sheet metal member 7 is electrically connected to the circuit substrate 5 via the head portion 8a.

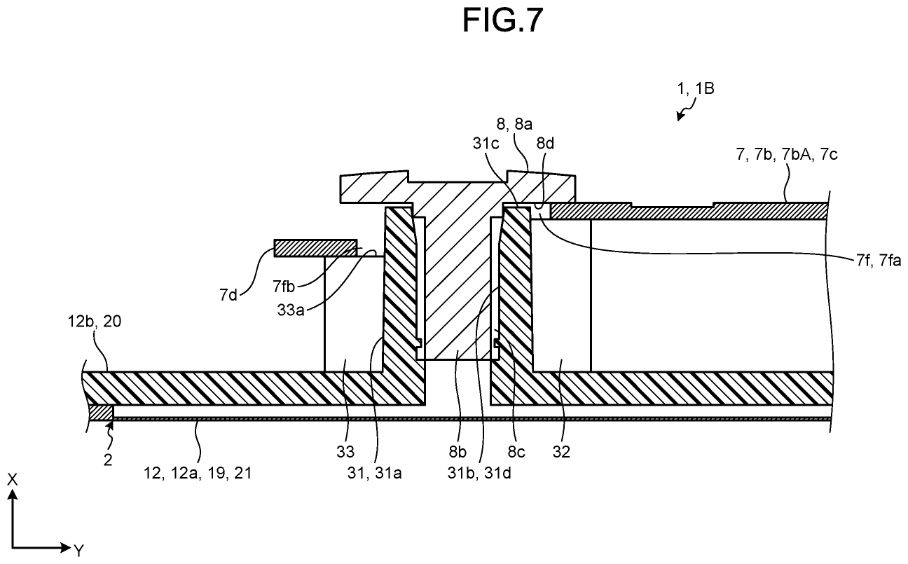

Next, the second electronic device 1B is described. FIG. 7 is an illustrative sectional view of a part of a rear unit in the electronic device 1 (second electronic device 1B).

The second electronic device 1B has a configuration similar to the configuration of the first electronic device 1A but is not provided with the circuit substrate 5 and the antenna connected to the circuit substrate 5. Thus, the male screw member 8 fixes only the sheet metal member 7 to the inner cover member 20.

As described above, the electronic device 1 includes the inner cover member 20 (support member), the male screw member 8, the sheet metal member 7 (first component), and the female screw 31d. The inner cover member 20 has the end surface 32a (first surface) facing in the X-direction (first direction) and the end surface 33a (second surface) facing in the X-direction (first direction). The male screw member 8 includes: the head portion 8a positioned in the X-direction with respect to the end surface 32a and the end surface 33a and spaced apart from the end surface 32a and the end surface 33a; and the shaft portion 8b extending from the head portion 8a in the direction opposite to the X-direction. The sheet metal member 7 is sandwiched between the head portion 8a and the end surface 32a. The female screw 31d is joined to the shaft portion 8b, thereby fixing the male screw member 8 to the inner cover member 20. The end surface 32a and the end surface 33a are at different positions in the X-direction and in the circumferential direction of the shaft portion 8b.

In such a configuration, the sheet metal member 7 and the circuit substrate 5 can be collectively fastened by the male screw member 8, for example, with the circuit substrate 5 (second component), which is a component other than the sheet metal member 7, interposed between the end surface 33a of the inner cover member 20 and the head portion 8a of the male screw member 8. Therefore, a configuration (the second electronic device 1B) in which the male screw member 8 fixes only the sheet metal member 7 to the inner cover member 20 or a configuration (the first electronic device 1A) in which the male screw member 8 fixes both the sheet metal member 7 and the circuit substrate 5 to the inner cover member 20 can be selectively obtained. That is, it is not necessary to prepare the male screw members 8 having different lengths according to a specification difference that is whether or not the circuit substrate 5 is included. That is, increase in number of kinds of male screw member 8 can be avoided.

In one or more embodiments, for example, the sheet metal member 7 includes: the first part 7c sandwiched between the head portion 8a and the end surface 32a; and the second part 7d positioned further in the direction opposite to the X-direction than the first part 7c is. Here, the thickness of the second part 7d in the X-direction (first direction) is smaller than the distance L2 between the end surface 33a and the head portion 8a in the X-direction.

In such a configuration, for example, the sheet metal member 7 and the circuit substrate 5 can be collectively fastened by the male screw member 8 with the circuit substrate 5 laid on the second part 7d of the sheet metal member 7. Therefore, for example, the second part 7d of the sheet metal member 7 and the circuit substrate 5 can be easily brought into electrical connection with each other.

In one or more embodiments, the electronic device 1 (second electronic device 1B) includes, for example, the circuit substrate 5 between the end surface 33a and the head portion 8a.

Such a configuration enables the same kind of male screw member 8 to be used also in, for example, another configuration in which the male screw member 8 fixes only the sheet metal member 7 to the inner cover member 20 (the first electronic device 1A). Thus, increase in number of kinds of male screw member 8 can be avoided.

In one or more embodiments, the electronic device 1 (first electronic device 1A) is provided with, for example, the circuit substrate 5 laid on the second part 7d in the X-direction. The second part 7d and the circuit substrate 5 are sandwiched between the end surface 33a and the head portion 8a, whereby the sheet metal member 7 and the circuit substrate 5 are electrically connected to each other via the head portion 8a while being electrically connected to each other by having the second part 7d and the circuit substrate 5 in contact with each other.

Such a configuration can increase the amount of electricity conducted between the sheet metal member 7 and the circuit substrate 5. Therefore, wireless communication of the circuit substrate 5 can operate more stably, for example. That is, a measure to ensure the electromagnetic compatibility (EMC) can be implemented.

The above embodiments illustrate an example in which the female screw 31d is formed by having the male screw member 8 screwed. However, the above example is not limiting. For example, a nut provided with a female screw 31d may be formed on the boss 31 by outsert molding.

In the above embodiments, the fixation piece 7bA has the stepped part 7g provided between the first part 7c and the second part 7d. However, the above example is not limiting. For example, the position of the second part 7d in the X-direction may be set to the same position as the position of the first part 7c in the X-direction. In this case, the fixation piece 5b of the circuit substrate 5 may be positioned on another side of the second part 7d that faces in a direction opposite to the X-direction.

The above embodiments are illustrated by, for example, the example in which, while the first component is the sheet metal member 7, the second component is the circuit substrate 5. However, the above example is not limiting. For example, each of the first component and the second component may be a storage device such as a hard disk drive.

According to the above aspect of the present invention, an electronic device that makes it possible to avoid increase in the number of kinds of male screw member can be obtained.

While certain embodiments have been described, these embodiments have been presented by way of example only, and are not intended to limit the scope of the inventions. Indeed, the embodiments described herein may be embodied in a variety of other forms; furthermore, various omissions, substitutions, combinations, and changes may be made without departing from the spirit of the inventions. In addition, specifications such as configurations and shapes (structure, kind, direction, form, size, length, width, thickness, height, number, arrangement, position, material, etc.) may be appropriately changed for implementation.

What is claimed is:

1. An electronic device comprising:
a support member including a first surface and a second surface, the first surface facing in a first direction, the second surface facing in the first direction;
a male screw member including a head portion and a shaft portion, wherein
the head portion is positioned in the first direction with respect to the first surface and the second surface and spaced apart from the first surface and the second surface, and
the shaft portion extends from the head portion in a direction opposite to the first direction;
a first component sandwiched between the head portion and the first surface; and
a female screw joined to the shaft portion and fixing the male screw member to the support member, wherein
the first surface and the second surface are at different positions in the first direction and in a circumferential direction of the shaft portion.

2. The electronic device according to claim 1, wherein
the first component includes a first part and a second part,
the first part is sandwiched between the head portion and the first surface,
the second part is positioned further in the direction opposite to the first direction than the first part is, and
a thickness of the second part in the first direction is smaller than a distance between the second surface and the head portion in the first direction.

3. The electronic device according to claim 1, further comprising a second component sandwiched between the second surface and the head portion.

4. The electronic device according to claim 2, further comprising a second component laid on the second part in the first direction with respect to the second part, wherein
the second part and the second component are sandwiched between the second surface and the head portion, and
the first component and the second component are electrically connected to each other by having the second part and the second component in contact with each other and are electrically connected to each other via the head portion.
